(19) United States
(12) Patent Application Publication
(10) Pub. No.: US 2018/0345635 A1
(43) Pub. Date: Dec. 6, 2018

(54) ELECTROSTATIC DISCHARGE POLYETHYLENE TEREPHTHALATE LABEL

(71) Applicant: Avery Dennison Corporation, Glendale, CA (US)

(72) Inventors: Changzhi WANG, Glendale, CA (US); Yu WANG, Glendale, CA (US); Shuhui Xie, Glendale, CA (US); Jun ZHANG, Glendale, CA (US)

(73) Assignee: Avery Dennison Corporation, Glendale, CA (US)

(21) Appl. No.: 15/992,552

(22) Filed: May 30, 2018

Related U.S. Application Data
(63) Continuation of application No. PCT/CN2017/086594, filed on May 31, 2017.

(51) Int. Cl. B32B 27/08; B32B 27/36; B32B 27/40; B32B 7/12; B32B 7/06

(52) U.S. Cl. CPC B32B 27/08; B32B 27/36; B32B 27/40; B32B 7/12; B32B 7/06; B32B 2264/105; B32B 2307/21; B32B 2367/00; B32B 2375/00; B32B 2264/102; B32B 2519/00

(57) ABSTRACT

ESD labels with a polyester-isocyanate topcoat are provided. The topcoat and adhesive layer may comprise conductive particles, and the percentage of conductive particles in the adhesive layer may be reduced as compared to labels without conductive particles in the topcoat. The ESD labels have reduced surface resistance in the topcoat and adhesive layer, while also having reduced peel-off voltage.

### FIELD OF THE INVENTION

The present invention relates generally to electrostatic discharge polyethylene terephthalate labels. The labels may include a polyester-isocyanate resin and conductive particles in a topcoat layer of the label, as well as conductive particles in an adhesive layer.

### BACKGROUND OF THE INVENTION

Electrostatic discharge (ESD) is caused by the accumulation of charge on the surfaces of insulators, such as plastics. These charges cannot move because there is no path to ground. Thus the charges are referred to as static charges. The static charge on the insulators may be discharged through a conductor, such as the metal leads on a circuit board or the relatively conductive skin of a person. Although the voltage of the ESD may be very low, e.g., 50 V, and may not even generate a spark, these ESDs may destroy, for example, the gate oxide layers inside of an integrated chip, rendering it useless. Even low voltage discharges can destroy a modern integrated circuit.

Electronic components, such as integrated chip circuits, often include labels. These labels, when peeled from the liner before application to the electronic part, can generate static charges that exceed hundreds of thousands of volts. Repositioning of the label also may generate static charge.

One conventional solution to the accumulation of static charge has been to impart conductivity to the label's insulative adhesive by incorporating conductive particles. US Pub. No. 2008/0026215 discloses a multi-layer label. The label includes a polymeric substrate having a print receptive layer on one major surface and a print contrast layer on the opposite major surface. The label also includes both an electrically conductive adhesive and an electrically conductive layer.

US Pub. No. 2016/0018748 discloses a multilayer laminate such as a label assembly having high opacity and desirable appearance characteristics. The laminate includes a facestock layer, an adhesive layer, and a liner layer. The facestock layer includes a print-receiving top coat layer that includes a combination of titanium dioxide and one or more optical brighteners. The combination of these materials avoids buildup of static charges upon laser printing on the facestock.

US Pub. No. 2002/0191331 discloses a pressure-sensitive adhesive label with a base having an information indication portion on its one surface thereof, and a pressure-sensitive adhesive layer formed on another surface of the base. After peeling a release liner, the label is stuck on an outer surface of a housing of the hard disk drive to reduce noise generated when the hard disk drive is driven. The release liner for coating the pressure-sensitive adhesive layer has an antistatic function and a cut line. The adhesive force of the adhesive layer is reduced by heating. The label has a surface density of not lower than 0.18 (kg/m²).

U.S. Pat. No. 5,789,123 discloses a label stock structure comprising a liquid toner printable thermoplastic film. The film is coated with an ethylene-acrylic acid copolymer based coating capable of electrostatic imaging with liquid toner. Optionally, the coating contains acrylic polymer. In a specific embodiment, the coating includes a major proportion of ethylene-acrylic acid and minor amounts of filler such as talc and silica. The coating can also include wax and/or pigment such as titanium dioxide. In a further embodiment, the carboxylate groups of the copolymer are neutralized with metal ions from Group Ia, IIa or IIb of the Period Table of the Elements, specifically, sodium.

None of the above-disclosed references, however, provide for cost effective labels with effective electrostatic dissipation properties. In view of the foregoing drawbacks, the need exists for a cost-effective label with low surface resistance and peel off voltage.

### SUMMARY OF THE INVENTION

In one embodiment, the invention relates to a label comprising: (i) a topcoat comprising a polyester-isocyanate resin; (ii) a polyethylene terephthalate film; and (iii) an adhesive layer. The label may further comprise (iv) a liner. The polyethylene terephthalate film may be configure to be between the topcoat and the adhesive layer.

The topcoat may comprise from 5 to 60 wt. % polyester-isocyanate resin. The topcoat may further comprise from 1 to 50 wt. % conductive particles. The topcoat may further comprise conductive particles selected from the group consisting of metal particles, metal coated particles, inorganic oxide particles with a conductive shell, carbon particles, graphite particles, conductive polymer particles, and combinations thereof. The topcoat may further comprise conductive titanium dioxide particles. In some aspects, the topcoat and adhesive layer may comprise conductive particles, and the conductive particles in the adhesive layer may be different than the conductive particles in the topcoat. In further aspects, the topcoat comprises conductive titanium dioxide particles and the adhesive layer comprises conductive nickel particles. The adhesive layer may comprise a pressure sensitive adhesive. The adhesive layer may comprise conductive particles, such as conductive nickel particles. The adhesive layer may comprise from 0.5 to 50 wt. % conductive particles, based on the total weight of the adhesive layer. The topcoat may have a thickness from 1 to 50 microns. The polyethylene terephthalate film may have a thickness from 1 to 200 microns. The adhesive layer may have a thickness from 1 to 100 microns. The label may have a peel-off voltage of less than 100 volts. The topcoat may have a surface resistance of less than 10¹¹ ohms. The adhesive layer may have a surface resistance of less than 10¹¹ ohms.

In further embodiments, the present invention is directed to a printed circuit board comprising a label as described above, adhered to at least one surface of the printed circuit board.

### BRIEF DESCRIPTION OF DRAWING

The invention is described in detail below with reference to the appended drawing.

FIG. 1 shows a cross-sectional view of a label in accordance with aspects of the invention.

### DETAILED DESCRIPTION OF THE INVENTION

Labels are often utilized in circuit board applications for labelling or protection. A label having electrostatic dissipation features may be useful in protecting electronic components from electrostatic discharge during application and removal of the label. It has now been discovered that the utilization of topcoat and/or facestock layers having particular compositions in combination with conductive particles in specific label layers provides for unexpected performance properties of the resultant label. For example, the use of an electrostatic dissipative topcoat comprising a polyester-isocyanate resin and conductive particles has been found to improve electrostatic dissipation. The resultant labels advantageously have a peeling voltage approaching zero and improved ESD functionality on the label surface. The use of a specific facestock film, e.g., a polyethylene terephthalate film, has been found to further contribute to the unexpected performance benefits.

Labels typically comprise an adhesive layer that optionally comprises functional particles. It has further been discovered that when the polyester-isocyanate resin and conductive particles are included in the topcoat layer (and optionally a primer layer), the amount or percentage of conductive particles required in the adhesive layer can beneficially be reduced. This reduction in the conductive particles in the adhesive layer results in improved adhesive properties while maintaining low surface resistance and peel-off voltage for the label.

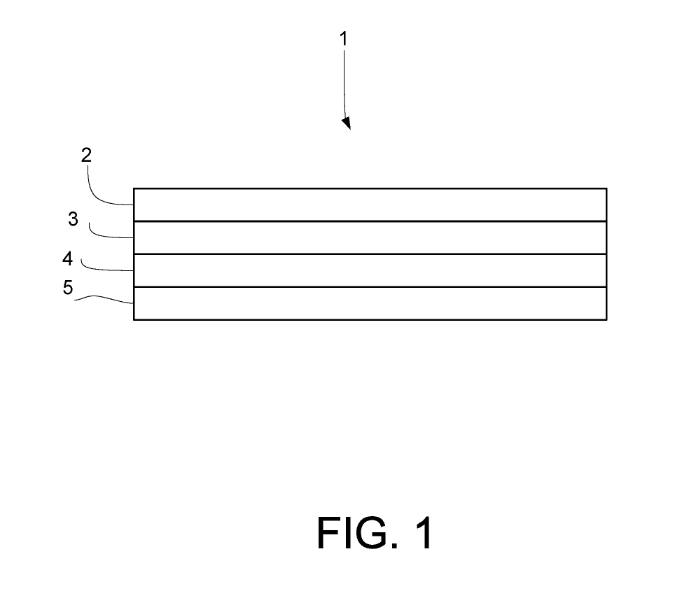

As shown in an exemplary embodiment, e.g., the embodiment of FIG. 1, ESD label 1 contains multiple, e.g., four, basic layers, although the present invention may include additional layers. The layers, in order from top to bottom, include a topcoat 2, a polyethylene terephthalate film 3 (“facestock”), an adhesive layer 4, e.g., pressure-sensitive adhesive 4, and a liner 5. An optional primer (not shown) may be disposed between the facestock and the adhesive layer. Each layer is described in further detail below.

### Topcoat

From the perspective looking downwardly toward a substrate, in one embodiment, the topcoat layer is, as the name implies, the top layer of the label, and is directly exposed to the surrounding environment. The topcoat layer is configured directly adjacent to the top surface of the polyethylene terephthalate film, e.g., the topcoat layer is positioned above the polyethylene terephthalate film. The topcoat may serve as a surface be marked with information, such as a barcode or alphanumeric characters, and may be thermal transfer printable and UV ink printable. Additionally, the topcoat provides protection for the remaining layers, e.g., the topcoat may be designed/selected to resist extreme temperature, solvent, and/or abrasion exposure. In one embodiment, the topcoat has a low surface resistance, e.g., less than 10¹¹ ohms, less than 5¹¹ ohms, less than 10¹⁰ ohms, or less than 10⁸ ohms. In terms of ranges, the surface resistance ranges from 10⁵ to 10¹¹ ohms, e.g., from 10⁵ to 10¹⁰ ohms or from 10⁵ to 10⁸ ohms. The low surface resistance provides for faster release speed for the accumulated static energy as well as reduced peel voltage during the manufacturing process. The low surface resistance also allows for use of the label for electronic device protection. The manufacturing process may include die-cutting and rewinding.

The thickness of the topcoat may vary widely. The topcoat may have a thickness ranging from 1 to 50 microns, e.g., from 1 to 25 microns, or from 1 to 20 microns. In terms of lower limits, the topcoat may have a thickness of at least 1 micron, e.g., at least 2 microns. In terms of upper limits, the topcoat may have a thickness less than 50 microns, e.g., less than 25 microns, or less than 20 microns. The thickness of the topcoat may be chosen based on the desired opacity of the topcoat as well as the desired stiffness of the topcoat.

The topcoat comprises a polyester-isocyanate resin. In preferred embodiments, the topcoat contains from 5 to 60 wt. % of a polyester-isocyanate resin, based on the total weight of the topcoat, e.g., 25 to 60 wt. % or from 30 to 50 wt. % In terms of upper limits, the topcoat contains up to 70 wt. % of a polyester-isocyanate resin, e.g., up to 60 wt. % or up to 50 wt. %. In terms of lower limits, the topcoat contains at least 20 wt. % polyester-isocyanate resin, e.g., at least 25 wt. %, or at least 30 wt. %. As with the thickness of the topcoat, the amount of resin may also be chosen based on the desired opacity of the topcoat as well as the desired stiffness of the topcoat. Generally, introducing conductive materials into the topcoat has a detrimental effect on the thermal printing performance. This detrimental effect is at least partially ameliorated by the use of the polyester-isocyanate resin.

In some cases, the ratio of polyester to isocyanate in the resin may range from 5:1 to 1:5, e.g., from 3:1 to 1:3, or from 1.5:1 to 1:1. In terms of upper limits, the ratio of polyester to isocyanate in the resin may be less than 5:1, e.g., less than 3:1, or less than 1.5:1. In terms of lower limits, the ratio of polyester to isocyanate in the resin may be at least 0.5:1, e.g., at least 1:1. The inventors have found that by keeping the ratio of polyester to isocyanate within these ranges, the topcoat has the beneficial combination of features of low surface resistance, printability, and solvent resistance.

The polyester may vary widely. For example, any suitable hydroxylated polyester may be used in the polyester-isocyanate resin. In some aspects, the polyester is a hydroxylated polyester that comprises hydroxyl group-terminated linear or branched polymers. For example, suitable hydroxylated polyesters may include polymerized copolyester resins such as VYLON 103, VYLON 200, VYLON 220, VYLON 240, VYLON 270, VYLON 300, VYLON 500, VYLON 226, VYLON 670, and VYLON 550 (all commercially available from Toyobo). Additional exemplary hydroxylated polyesters may comprise a range of high-molecular weight and medium-molecular weight copolyesters (e.g., molecular weight ranging from about 2,000 grams per mole to about 20,000 grams per mole). Exemplary commercial products include DYNAPOL L912, DYNAPOL L952, DYNAPOL L206, DYNAPOL L205, DYNAPOL L208, DYNAPOL L210, DYNAPOL L411, DYNAPOL L850, DYNAPOL L658, DYNAPOL LH815, DYNAPOL LH830, DYNAPOL LH828, and DYNAPOL LH744 (all commercially available from Evonik Degussa).

The polyester may be reacted with an isocyanate resin to form the polyester-isocyanate resin. As described herein, the isocyanate compound refers to a product comprising of one or more polyisocyanate reactive groups. As used herein, the term “polyisocyanate” includes compounds, monomers, oligomers and polymers comprising at least two N═C═O functional groups. Suitable polyisocyanates for use in preparing the isocyanate functional prepolymer of the compositions of the present invention include monomeric, oligomeric and/or polymeric polyisocyanates. The polyisocyanates can be C₂-C₂₀ linear, branched, cyclic, aromatic, aliphatic, or combinations thereof.

Suitable polyisocyanates for use in the present invention may include, but are not limited to, isophorone diisocyanate (IPDI), which is 3,3,5-trimethyl-5-isocyanato-methyl-cyclohexyl isocyanate; hydrogenated materials, such as cyclohexylene diisocyanate, 4,4′-methylenedicyclohexyl diisocyanate (H₁₂MDI); mixed aralkyl diisocyanates, such as tetramethylxylyl diisocyanates, OCN—C(CH₃)₂—C₆H₄C(CH₃)₂—NCO; polymethylene isocyanates, such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

As indicated, in certain embodiments, the polyisocyanate can include an oligomeric polyisocyanate, such as, but not limited to, dimers, such as the uretdione of 1,6-hexamethylene diisocyanate, trimers, such as the biuret and isocyanurate of 1,6-hexanediisocyanate and the isocyanurate of isophorone diisocyanate, allophonates, and polymeric oligomers. Modified polyisocyanates can also be used, including carbodiimides and uretone-imines, and mixtures thereof. Suitable materials include those available under the designation DESMODUR from Bayer Corporation of Pittsburgh, Pa., such as DESMODUR N 3200, DESMODUR N 3300 (hexamethylene diisocyanate trimer), DESMODUR N 3400 (60% hexamethylene diisocyanate dimer and 40% hexamethylene diisocyanate trimer), DESMODUR XP 2410 and DESMODUR XP 2580. DESMODUR N75, DESMODUR N100 (hexamethylene diisocyanate dimer).

The topcoat may also comprise conductive particles. The conductive particles may be present from 1 to 50 wt. %, based on the total weight of the topcoat, e.g., from 5 to 40 wt. %, or from 10 to 30 wt. %. In terms of upper limits, the topcoat comprises no more than 50 wt. % conductive particles, e.g., no more than 40 wt. %, or no more than 30 wt. %, based on the total weight of the topcoat. In terms of lower limits, the topcoat comprises at least 1 wt. % conductive particles, e.g., at least 5 wt. % or at least 10 wt. %, based on the total weight of the topcoat. The conductive particles are dispersed throughout the topcoat, generally with a high speed dispersion machine followed by filtration through a filter bag. The conductive particles may include at least one of metal particles, metal coated particles, inorganic oxide particles with a conductive shell, carbon particles, graphite particles, and conductive polymer particles. In some aspects, conductive titanium dioxide particles may be used and specifically, needle type conductive titanium dioxide may be used. The addition of the conductive particles, contributes to the surprising benefit of low surface resistance and reduced peel voltage.

In embodiments where metal particles are utilized, the metal particles may include those of silver, gold, copper, nickel, aluminum, iron and steel. When metal-coated particles are employed, the metal-coated particles may include those in which one or more of these or other metals are coated on a core material such as carbon, graphite, polymeric or glass spheres or another metal. The conductive particle for use in a topcoat is chosen based on a number of factors, e.g., loading requirements, the amount of surface resistivity the particle imparts to the topcoat, and cost.

In some aspects, the conductive particles are core-shell particles in which a nonconductive core (usually an oxide or mineral particle) carries a thin outer shell of a conductive material. Examples include the Zelec brand of conductive pigments from E. I. Du Pont de Nemours, Co. in which the core is either a titanium dioxide particle or mica flake and the conductive outer shell is antimony doped tin oxide. Zelec ECP 3410T (which has a titanium dioxide core) is an exemplary conductive particle. Polyaniline as available from Monsanto Co. is representative of the conductive polymers in particle or soluble form.

The topcoat, in accordance with certain embodiments of the present invention, may be applied onto a film (facestock) by any known techniques in the art, such as spray, roll, brush, or other techniques. In some embodiments, the topcoat layer may be coated onto the as a solvent-based system. Although polyethylene terephthalate film is recited as the facestock herein, other films having acceptable anchorage may also be used as a facestock. The amount of carriers and/or solvent(s) in the topcoat composition may vary depending on the desired coating viscosity. In accordance with certain embodiments, the solvent(s) may comprise any conventional solvent for polyesters and melamine resin systems. For example, such solvents may include ketones of from 3 to 15 carbon atoms (e.g., methyl ethyl ketone or methyl isobutyl ketone), alkylene glycols and/or alkylene glycol alkyl ethers having from 3 to 20 carbon atoms, acetates and their derivatives, ethylene carbonate, and other suitable solvents. Suitable alcohol solvents include mono-alcohols, such as methyl, ethyl, propyl, butyl alcohols, as well as cyclic alcohols such as cyclohexanol. In certain embodiments, most acetate-type solvents may be used, such as n-butyl acetate, n-propyl acetate, and other acetate-type solvents. In accordance with certain embodiments, a portion of the solvent system may include water is so desired. In other embodiments, however, the solvent system may be devoid of water.

### Polyethylene Terephthalate Film

As noted above, the labels may comprise at least one polyethylene terephthalate film that is directly adjacent to the topcoat. The polyethylene terephthalate film has top and bottom surfaces. From the perspective looking downwardly toward the substrate, the polyethylene terephthalate film may be configured beneath the topcoat, e.g., the top surface of the polyethylene terephthalate film is adjacent the topcoat. It has now been discovered that this configuration, e.g., polyethylene terephthalate film in combination with the aforementioned topcoat and/or adhesive layers, contributes to the unexpected performance benefits. The polyethylene terephthalate film may be biaxially oriented.

The polyethylene terephthalate films according to certain embodiments of the present invention may comprise a thickness ranging from 1 to 200 microns, e.g., from 10 to 300 microns, from 25 to 200 microns, or from 50 to 150 microns, and other ranges in the foregoing amounts. In terms of lower limits, the polyethylene terephthalate films may have a thickness of at least 1 micron, e.g., at least 10 microns, at least 25, or at least 50 micros. In terms of upper limits, the polyethylene terephthalate films may have a thickness less than 400 microns, e.g., less than 300 microns, less than 200 microns, or less than 150 microns.

### Primer Layer

An optional primer layer may be directly adjacent to the polyethylene terephthalate film on the opposite surface of the polyethylene terephthalate film from the topcoat, e.g., the polyethylene terephthalate film may be configured between the topcoat and the primer layer. The primer layer may comprise a polyester-polyethylene terephthalate resin and conductive particles. The polyester-polyethylene terephthalate resin and conductive particles employed in the primer layer may be as described above for the topcoat, though the final compositions of the primer layer and the topcoat may be different. Also, the optional additives described for the topcoat may be utilized in the primer layer. In some embodiments, the composition of the topcoat is different from the composition of the primer layer. For example, the primer layer may comprise the same polyester-polyethylene terephthalate resin as the topcoat, the same conductive particles, but different additives as described herein. In some cases, the composition of the topcoat may be the same as the composition of the primer layer. In other cases, the primer layer may comprise a greater percentage of conductive particles than the topcoat since there is no printing on the primer layer. For example, the conductive particles may be present from 1 to 90 wt. %, based on the total weight of the topcoat, e.g., from 5 to 80 wt. %, or from 10 to 70 wt. %. In terms of upper limits, the topcoat comprises no more than 90 wt. % conductive particles, e.g., no more than 80 wt. %, or no more than 70 wt. %, based on the total weight of the topcoat. In terms of lower limits, the topcoat comprises at least 1 wt. % conductive particles, e.g., at least 5 wt. % or at least 10 wt. %, based on the total weight of the topcoat.

In preferred embodiments, the conductive particles in the primer layer include at least one of least one of metal particles, metal coated particles, inorganic oxide particles with a conductive shell, carbon particles, graphite particles, and conductive polymer particles. In some aspects, conductive titanium dioxide particles may be used and specifically, needle type conductive titanium dioxide may be used in both the topcoat and primer layer. The primer layer may have a surface resistance of less than 10¹¹ ohms, e.g., less than 5⁹ ohms, or less than 1⁹ ohms. Without being bound by theory, by including conductive particles in the primer layer, the ESD performance on peel off voltage is surprisingly improved while the adhesion of the label is not compromised. The label may give a peel-off voltage of less than 100 volts, e.g., less than 40 volts, less than 30 volts, or less than 25 volts.

The primer layer may be coated onto the polyethylene terephthalate film by gravure or comma. After curing at a temperature from about 100 to 180° C., the primer is affixed to the film. Additionally, when crosslinker is included in the primer layer, the hydroxyl group on the polyolefin film with react with the crosslinker and thus the primer layer is be chemically bonded to the polyolefin film.

The thickness of the primer layer may range from 0.01 to 50 microns, e.g., from 0.1 to 25 microns, or from 0.5 to 10 microns. In terms of lower limits, the primer layer may have a thickness of at least 0.01 micron, e.g., at least 0.1 microns, or at least 0.5 micros. In terms of upper limits, the primer layer may have a thickness less than 50 microns, e.g., less than 25 microns, or less than 10 microns.

Adhesive Layer

The adhesive layer, according to certain embodiments of the present invention, may comprise any adhesive that is effective in binding the label to an external surface of the substrate to which the label may be affixed.

As noted above, the adhesive layer may also comprise conductive particles as described for the topcoat. The conductive particles in the adhesive layer may be the same as in the topcoat, or may be different. For example, the topcoat could contain the conductive titanium dioxide, while the adhesive layer may contain different conductive particles, such as nickel particles. In further embodiments, the adhesive layer contains the same conductive particles as the topcoat. Preferably, the conductive particles of the adhesive layer include at least one of metal particles, metal coated particles, inorganic oxide particles with a conductive shell, carbon particles, graphite particles, and conductive polymer particles. In some aspects, conductive nickel particles are used. By including conductive particles in the topcoat (and optionally in the primer), the amount of conductive particles in the adhesive layer may be beneficially reduced. The resultant labels advantageously demonstrate beneficial performance properties, e.g., improved adhesion, ESD functionality and/or peeling voltage.

The conductive particles in the adhesive may be present from 0.5 to 50 wt. %, based on the total weight of the adhesive layer, e.g., from 2 to 15 wt. % or from 2 to 10 wt. %. In terms of lower limits, the adhesive layer comprises at least 1 wt. % conductive particles, e.g., at least 2 wt. % or at least 5 wt. %, based on the total weight of the adhesive layer. In terms of upper limits, the adhesive layer comprises no more than 20 wt. % conductive particles, e.g., no more than 15 wt. % or no more than 10 wt. %, based on the total weight of the adhesive layer. As explained herein, by reducing the weight percent of conductive particles in the adhesive layer as compared to conventional labels, the label has improved performance properties, e.g., heat resistance and peel strength. The adhesive layer may contain less than 75% of the weight percentage of conductive particles in a conventional label, e.g., less than 50%, less than 25%, or less than 10%.

In some embodiments, the adhesive exhibits good heat resistance and peel strength, e.g., a peel strength from 0.5 to 100 N/inch or greater, e.g., at least 9N/inch on a steel panel, at least 9.5N/inch or at least 10N/inch. In some aspects, the adhesive may be a pressure sensitive adhesive. Importantly, when the aforementioned topcoat and/or primer layer compositions are employed, the amount of conductive particles in the adhesive layer can be reduced, which results in improved adhesiveness while maintaining low surface resistance and peel-off voltage for the label. Thus, the adhesive layer may have a lower conductive particle content, while still providing suitable performance.

The adhesive layer may have a thickness from 1 to 100 microns, e.g., from 5 to 100 microns, or from 10 to 50 microns. In terms of lower limits, the adhesive layer may have a thickness of at least 1 micron, e.g., at least 5 microns, or at least 10 micros. In terms of upper limits, the primer layer may have a thickness less than 100 microns, e.g., less than 50 microns.

In some embodiments, the adhesive may exhibit heat resistance at temperatures of up to 200° C., 225° C., 250° C., 260° C., or 270° C. In some embodiments, the adhesive also may exhibit cohesive strength and high shear resistance. The adhesive layer may have a surface resistance of less than 10¹¹ ohms, e.g., less than 1*10⁹ ohms, or less than 5*10⁹ ohms.

An aggressive pressure sensitive adhesive may be used, such as one of the high-strength or rubber-modified acrylic pressure sensitive adhesives, such as Duro-Tak® 80-115 A available from National Starch and Chemical Co. or Aroset™ 1860-Z-45 available from Ashland Specialty Chemical Company. Suitable pressure sensitive adhesives may include, for example, copolymers of alkyl acrylates that have a straight chain of from 4 to 12 carbon atoms and a minor proportion of a highly polar copolymerizable monomer such as acrylic acid. These adhesives are more fully described in U.S. Pat. Re. 24,906 and U.S. Pat. No. 2,973,286, the contents of each are hereby incorporated by reference in their entirety. Alternative pressure sensitive adhesives include ultraviolet curable pressure sensitive adhesives, such as Duro-Tak 4000, which is available from National Starch and Chemical Co.

The adhesive layer may also contain additives as described herein, including antioxidants and cross-linkers, in amounts of less than 5 wt. % based on the total weight of the adhesive layer, e.g., less than 4 wt. % or less than 3 wt. %.

### Liner

In accordance with certain embodiments of the present invention, the labels may comprise a releasable liner. The releasable liner may be positioned directly adjacent to the adhesive layer, on the opposite side of the adhesive layer from the primer layer. In this regard, the releasable liner may protect the adhesive layer before the label is applied (or intended to be applied) to an object or facestock, such as during manufacture, printing, shipping, storage, and at other times. Any suitable material for a releasable liner may be used. Typical and commercially available releasable liners, which can be suitable for embodiments of the present invention, can include a silicone-treated release paper or film, such as those available from Loparex, including products such as 1011, 22533 and 1 1404, CP Films, and Akrosil™. Additional papers or films may also be used. In some aspects, the liner is a paper liner or film liner.

### Additives

The topcoat and/or adhesive layer may optionally include one or more fillers and/or additives. Such fillers and/or additives, for example, may be incorporated into the topcoat and/or adhesive layer in conventional quantities using conventional equipment and techniques. For example, representative fillers can include tale, calcium carbonate, organo-clay, glass fibers, marble dust, cement dust, feldspar, silica or glass, fumed silica, silicates, alumina, various phosphorus compounds, ammonium bromide, titanium dioxide, antimony trioxide, antimony trioxide, zinc oxide, zinc borate, barium sulfate, silicones, aluminum silicate, calcium silicate, glass microspheres, chalk, mica, clays, wollastonite, ammonium octamolybdate, intumescent compounds and mixtures of two or more of these materials. The fillers may also carry or contain various surface coatings or treatments, such as silanes, fatty acids, and the like. Still other fillers can include flame retardants, such as the halogenated organic compounds. In certain embodiments, the topcoat layer may include one or more thermoplastic elastomers that are compatible with the other constituents of the layer, such as etherified melamine, hydroxylated polyester, polyester-melamine, and other suitable elastomers.

The topcoat and/or adhesive layer can also include pigment dispersants, such as Nuosperse® 657 available from Elementis Specialties. In accordance with certain embodiments, the topcoat layer may also include carbon pigments, such as carbon black, ivory black, or the like, and/or one or more of a variety of other pigments, such as copper pigments (e.g., phthalocyanine dyes such as phthalocyanine blue), cadmium pigments (e.g., cadmium yellow), chromium pigments (e.g., chrome yellow), cobalt pigments (e.g., cobalt blue), iron oxide pigments (e.g., oxide red), and any other suitable pigments. Any colorants, pigments, and pigment dispersant are suitable to the extent that they do not interfere with desired loadings and/or physical or mechanical properties of the topcoat and/or adhesive layer. The overall label color may be white, black, or other colors. Additionally, the label may be matte or glossy.

In accordance with certain embodiments, the topcoat and/or adhesive layer can also include one or more flow and/or leveling agent to mitigate the occurrence of any surface defects (e.g., formation of pinholes, cratering, peeling, scarring, blistering, air bubbles, etc.). Suitable flow and/or leveling agents utilized are those that do not interfere with desired loadings and/or physical or mechanical properties of the topcoat. In certain embodiments, for instance, several commercially available flow and/or leveling agents may be utilized, including, for example BYK-392 (solution of a polyacrylate) from BYK Additives & Instruments; BY-310 (solution of a polyester modified polydimethylsiloxane) from BYK Additives & Instruments; EFKA 3277 (fluorocarbon modified polyacrylate) from BASF, and/or EFKA 3740 (polyacrylate) from BASF.

The topcoat and/or adhesive layer may also include one or more defoaming agents. A defoaming agent generally reduces or mitigates the formation of foaming in the topcoat layer when deposited or generally handled or transferred from one location to another. Generally, any defoaming agent that does not interfere with the other components of the topcoat may be included. For instance, the defoaming agent may be mineral-based, silicone-based, or non-silicone-based.

In accordance with some embodiments, the topcoat and/or adhesive layer may also include one or more antioxidants. Any suitable antioxidants for a particular embodiment may be used. In some embodiments, antioxidants may be selected that exhibit good heat resistance and mitigate the discoloration of polymeric-based articles/coatings. Exemplary antioxidants suitable for use according to certain embodiments of the present invention include, but not limited to, CHINOX 626, CHINOX 62S (organophophite antioxidant), CHINOX 245 (steric hindered phenolic antioxidant), and CHINOX 30N (blend of hindered phenolic antioxidants), each of which is commercially available from Double Bond Chemical Ind., Co., Ltd.

The topcoat and/or adhesive layer may also include one or more matting agents which may facilitate formation of a smooth layer. Any suitable matting agent for a particular embodiment may be utilized. In some embodiments, the matting agents may have a small particle size. For example, in some embodiments, the matting agents may have a particle size of less than 10 microns on average or less than 5 microns on average, such as modified or surface treated silica. The silica may be treated a variety of organic polymers depending on the particular resin system employed in the topcoat layer. In certain embodiments, the matting agent may include untreated silicon dioxide.

According to certain embodiments of the present invention, suitable catalyst may also be used. For instance, the constituents of the topcoat may include one or more acid catalysts, such as para-toluene sulfonic acid (PTSA) or methyl sulfonic acid (MSA). Useful acid catalysts may include, by way of example, boric acid, phosphoric acid, sulfate acid, hypochlondes, oxalic acid and ammonium salts thereof, sodium or barium ethyl sulfates, sulfonic acids, and similar acid catalysts. Other useful catalysts, according to certain embodiments, may include dodecyl benzene sulfonic acid (DDBSA), amine blocked alkane sulfonic acid (MCAT 12195), amine blocked dodecyl para-toluene sulfonic acid (B YK 460), and amine blocked dodecyl benezene sulfonic acid (Nacure 5543).

The following embodiments are contemplated. All combinations of features and embodiments are contemplated.

### Embodiment 1

A label comprising: (i) a topcoat comprising a polyester-isocyanate resin; (ii) a polyethylene terephthalate film; and (iii) an adhesive layer, wherein at least one of the topcoat and the adhesive layer comprise conductive particles; and further wherein the polyethylene terephthalate film is configured between the topcoat and the adhesive layer.

### Embodiment 2

An embodiment of embodiment 1, wherein the label further comprises: (iv) a liner.

### Embodiment 3

An embodiment of any one of embodiments 1-2, wherein the topcoat comprises from 5 to 60 wt. % polyester-isocyanate resin.

### Embodiment 4

An embodiment of any one of embodiments 1-3, wherein the polyester-isocyanate resin is formed by reacting a hydroxylated polyester with a polyisocyanate.

### Embodiment 5

An embodiment of any one of embodiments 1-4, wherein the topcoat further comprises from 1 to 50 wt. % conductive particles.

### Embodiment 6

An embodiment of any one of embodiments 1-5, wherein the topcoat further comprises conductive particles selected from the group consisting of metal particles, metal coated particles, inorganic oxide particles with a conductive shell, carbon particles, graphite particles, conductive polymer particles, and combinations thereof.

### Embodiment 7

An embodiment of any one of embodiments 1-6, wherein the topcoat further comprises conductive titanium dioxide particles.

### Embodiment 8

An embodiment of any one of embodiments 1-7, wherein the adhesive layer comprises conductive particles.

### Embodiment 9

An embodiment of any one of embodiments 1-8, wherein the adhesive layer comprises conductive nickel particles.

### Embodiment 10

An embodiment of any one of embodiments 1-9, wherein the topcoat and adhesive layer comprise conductive particles, and wherein the conductive particles in the adhesive layer are different than the conductive particles in the topcoat.

### Embodiment 11

An embodiment of any one of embodiments 1-10, wherein the topcoat comprises conductive titanium dioxide particles and the adhesive layer comprises conductive nickel particles.

### Embodiment 12

An embodiment of any one of embodiments 1-11, wherein the adhesive layer comprises a pressure sensitive adhesive.

### Embodiment 13

An embodiment of any one of embodiments 1-12, wherein the adhesive layer comprises from 0.5 to 50 wt. % conductive particles, based on the total weight of the adhesive layer.

### Embodiment 14

An embodiment of any one of embodiments 1-13, wherein the topcoat has a thickness from 1 to 50 microns.

### Embodiment 15

An embodiment of any one of embodiments 1-14, wherein the polyethylene terephthalate film has a thickness from 1 to 200 microns.

### Embodiment 16

An embodiment of any one of embodiments 1-15, wherein the adhesive layer has a thickness from 1 to 100 microns.

### Embodiment 17

An embodiment of any one of embodiments 1-16, wherein the label has a peel-off voltage of less than 100 volts.

### Embodiment 18

An embodiment of any one of embodiments 1-17, wherein the topcoat has a surface resistance of less than 10¹¹ ohms.

### Embodiment 19

An embodiment of any one of embodiments 1-18, wherein the adhesive layer has a surface resistance of less than 10¹¹ ohms.

### Embodiment 20

A printed circuit board comprising a label according to any one of embodiments 1-19, adhered to at least one surface of the printed circuit board.

The present invention will be better understood in view of the following non-limiting examples.

### EXAMPLES

### Example 1

A label according to the present invention was prepared as follows. The label contained, in order from top to bottom, a topcoat, a polyethylene terephthalate film, an adhesive layer, and a liner. The topcoat was formed from a polyester-isocyanate resin, had a thickness of 10 microns and contained 20 wt. % of conductive TiO₂. The surface resistance of the topcoat was 10⁹ ohms. The adhesive layer contained a pressure-sensitive adhesive, had a thickness of 25 microns and contained 30 wt. % nickel. The surface resistance of the adhesive layer was 10¹⁰ ohms. The peel strength of the adhesive layer was 12 N/inch as measured by peeling from a steel panel.

### Example 2

A label was prepared as in Example 1, except that the amount of conductive TiO₂ in the topcoat was 35 wt. % of conductive TiO₂. The surface resistance of the topcoat was 10⁸ ohms. The peel strength of the adhesive layer was 11 N/inch as measured by peeling from a steel panel.

### Comparative Example A

A label was prepared as in Example 1, except that the adhesive layer was adjusted to contain about 60 wt. % conductive nickel powder. The surface resistance of the adhesive layer was greater than 10¹² ohms and the adhesive performance was reduced to almost zero, as compared to Example 1.

### Comparative Example B

A label was prepared as in Example 1, except that the topcoat contained 70 wt. % of conductive TiO₂. The surface resistance of the topcoat was from 10⁶ to 10⁷ ohms but the TT-printing performance was very poor. Additionally, the ink peeled off during the tape test.

### Comparative Example C

A label was prepared as in Example 1, except that the adhesive layer contained 20 wt. % nickel. The surface resistance of the adhesive layer was from 10⁷ to 10¹¹ ohms. The peel strength of the adhesive layer was less than 5N/inch as measured by peeling from a steel panel.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

1. A label comprising:
(i) a topcoat comprising a polyester-isocyanate resin;
(ii) a polyethylene terephthalate film; and
(iii) an adhesive layer,
wherein at least one of the topcoat and the adhesive layer comprise conductive particles; and further wherein the polyethylene terephthalate film is configured between the topcoat and the adhesive layer.

2. The label according to claim 1, wherein the label further comprises:
(iv) a liner.

3. The label according to claim 1, wherein the topcoat comprises from 5 to 60 wt. % polyester-isocyanate resin.

4. The label according to claim 1, wherein the polyester-isocyanate resin is formed by reacting a hydroxylated polyester with a polyisocyanate.

5. The label according to claim 1, wherein the topcoat further comprises from 1 to 50 wt. % conductive particles.

6. The label according to claim 1, wherein the topcoat further comprises conductive particles selected from the group consisting of metal particles, metal coated particles, inorganic oxide particles with a conductive shell, carbon particles, graphite particles, conductive polymer particles, and combinations thereof.

7. The label according to claim 1, wherein the topcoat further comprises conductive titanium dioxide particles.

8. The label according to claim 1, wherein the adhesive layer comprises conductive particles.

9. The label according to claim 1, wherein the adhesive layer comprises conductive nickel particles.

10. The label according to claim 1, wherein the topcoat and adhesive layer comprise conductive particles, and wherein the conductive particles in the adhesive layer are different than the conductive particles in the topcoat.

11. The label according to claim 1, wherein the topcoat comprises conductive titanium dioxide particles and the adhesive layer comprises conductive nickel particles.

12. The label according to claim 1, wherein the adhesive layer comprises a pressure sensitive adhesive.

13. The label according to claim 1, wherein the adhesive layer comprises from 0.5 to 50 wt. % conductive particles, based on the total weight of the adhesive layer.

14. The label according to claim 1, wherein the topcoat has a thickness from 1 to 50 microns.

15. The label according to claim 1, wherein the polyethylene terephthalate film has a thickness from 1 to 200 microns.

16. The label according to claim 1, wherein the adhesive layer has a thickness from 1 to 100 microns.

17. The label according to claim 1, wherein the label has a peel-off voltage of less than 100 volts.

18. The label according to claim 1, wherein the topcoat has a surface resistance of less than 1011 ohms.

19. The label according to claim 1, wherein the adhesive layer has a surface resistance of less than 10¹¹ ohms.

20. A printed circuit board comprising a label according claim 1, adhered to at least one surface of the printed circuit board.
